(19) United States
(12) Patent Application Publication
(10) Pub. No.: US 2010/0070406 A1
(43) Pub. Date: Mar. 18, 2010

(54) INTEGRATED MORTGAGE AND REAL ESTATE ORIGINATION SYSTEM

(76) Inventor: Adam L. Stein, Auburn, WA (US)

Correspondence Address: MORRISS OBRYANT COMPAGNI, P.C., 734 EAST 200 SOUTH, SALT LAKE CITY, UT, 84102, US

(21) Appl. No.: 12/560,262

(22) Filed: Sep. 15, 2009

Related U.S. Application Data
(60) Provisional application No. 61/097,147, filed on Sep. 15, 2008.

(51) Int. Cl. G06Q 40/00; G06Q 50/00

(52) U.S. Cl. 705/38; 705/35

(57) ABSTRACT

Computer software for generating customer leads comprises a data input module for receiving potential customer data from an outside source and converting the data into a format compatible with preexisting software of an end user, a data storage module for storing the converted data, and a processing module for processing the converted data to determine a transaction type and for forwarding the converted data to the user based upon the determined transaction type. The converted data is displayable on a computer screen of the user by the user's preexisting software and provides the determined transaction type and client contact information.

### CROSS-REFERENCE TO RELATED APPLICATION

The present application claims priority to U.S. Provisional Patent Application Ser. No. 61/097,147 filed on Sep. 15, 2009, the entirety of which is incorporated by this reference.

### FIELD OF THE INVENTION

The invention relates to a method and system for acquiring, organizing and/or presenting loan applicant information, and more specifically to a method and system for creating lead generation for mortgage loan originators and real estate agents.

### SUMMARY OF THE INVENTION

The present invention provides a method and system for creating quality lead generation for loan originators and real estate agents by providing them with a high volume of high quality leads. The mortgage and real estate lead generation system of the present invention provides leads of consumers actively searching the Internet for mortgages or real estate, consumers currently pursuing mortgage transactions and consumers who have been identified to have a current need to refinance an existing loan.

The system of the present invention filters consumer data to increase the quality of leads to increase the possibility of the originator receiving the data to obtain a valid customer. The filters include, among others, the loan size, whether the loan is for a purchase or refinance, if there is a request for receiving cash out from the transaction, the interest rate and term and the credit score of the potential customer, the cost and location of real estate, etc.

In one embodiment according to the present invention, the data is compiled and converted into an LOS platform, which is a standard used by most loan originators, that allows the loan originators receiving the data to use it efficiently and productively.

Once a potential client is established, the client information is stored in a client retention module. The system then periodically and automatically sends messages to the client, e.g., via email, on various topics that provide information to the client about the originating company using the system (for advertising purposes) of the present invention, the client's financing or other useful information such as home buying tips for purchase transactions, information about choosing the right loan product, information to discern between fee and no fee offers, etc. The system tailors the information provided to the client based on the type of transaction the consumer is looking to obtain and relative to the time frame of the request. This messaging feature helps to make the originators more successful by consistently reminding the client of the origination company with useful messages.

Because over seventy percent of mortgage and real estate consumers begin their search on the Internet, the system of the present invention is designed to provide real time delivery of consumer data to originators. These real-time, customer disclosures allow the originators to reach potential customers while they are still searching on-line. As such, the originators can provide immediate response by quickly providing Good Faith Estimates and Truth In Lending Disclosures that mach the customer's request while still on-line. This process expedites the time within which the loan can be tailored to the client's needs and disclosure and loan closure can quickly happen.

The system also stores and reports usage data to the senior user of the system (e.g., a primary provider of the system). Using information reported by the system, such as the number of leads handle by individual originators, the number of contacts reported by the sales staff, the number of application received and the number of loans in processing and funded, the senior user can monitor and report success rates and effectiveness of the system.

In one embodiment, the system is dependent upon receiving lead data from specific Internet sources. The lead data is then provided to subscribers and/or users of the system. In order to preserve the quality of the lead data to each subscriber or user, the same lead data may not be provided to more than one subscriber or user to ensure that each subscriber or user is provided with unique opportunities for client generation.

The foregoing advantages and characterizing features will become apparent from the following description of certain illustrative embodiments of the invention. The above-described features and advantages of the present invention, as well as additional features and advantages, will be set forth or will become more fully apparent in the detailed description that follows and in the appended claims. The novel features which are considered characteristic of this invention are set forth in the attached claims. Furthermore, the features and advantages of the present invention may be learned by the practice of the invention, or will be obvious to one skilled in the art from the description, as set forth hereinafter.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a schematic flow diagram of a first embodiment of a system for generating customer leads in accordance with the principles of the present invention.

FIG. 2 is a schematic flow diagram of a second embodiment of a system for generating customer leads in accordance with the principles of the present invention.

FIG. 3 is a schematic flow diagram of a data input module of a system for generating customer leads in accordance with the principles of the present invention.

FIG. 4 is a schematic flow diagram of a data storage module of a system for generating customer leads in accordance with the principles of the present invention.

FIG. 5 is a schematic flow diagram of a client retention module of a system for generating customer leads in accordance with the principles of the present invention.

FIG. 6 is a schematic flow diagram of a processor module of a system for generating customer leads in accordance with the principles of the present invention.

FIG. 7A is a schematic flow diagram of a real estate module of a system for generating customer leads in accordance with the principles of the present invention.

FIG. 7B is a schematic flow diagram of a real estate online module of a system for generating customer leads in accordance with the principles of the present invention.

FIG. 8 is a schematic flow diagram of a loan operation system of a system for generating customer leads in accordance with the principles of the present invention.

FIG. 9 is a schematic flow diagram of a consumer communication module of a system for generating customer leads in accordance with the principles of the present invention.

FIG. 10 is a schematic flow diagram of a client support module of a system for generating customer leads in accordance with the principles of the present invention.

### DETAILED DESCRIPTION OF THE ILLUSTRATED EMBODIMENTS

The present invention provides a method and system, in the form of computer software operated on a computer system, mainframe, local area network and/or global Internet system, for gathering, compiling and reporting mortgage loan origination information. The system provides automatic input of data into a separate automated loan operating system and provides a method of triggering a customer retention module of the software that automatically sends introductory and/or informational emails to a potential consumer or potential borrower. Consumer data may be obtained from various sources. For example, online vendors that offer consumer financing and/or home buying information often request and obtain consumer data. Likewise, credit repositories obtain various credit information about consumers and will often sell consumer inquiry information relative to information related to home purchase requests and home refinance requests. Other data sources may come from title companies and ancillary data companies that determine loan information and consumer demographic information. These sources typically contain a blend of information depending on the source, such as the consumer's name, address, telephone, email address, underlying loan amounts, value of subject property, income level, credit scores, loan purpose, adjustable or fixed rate information, etc. The system of the present invention utilizes this information to generate leads for mortgage loan originators and real estate agents. Of course, upon review of the concepts set forth by the present invention, those of skill in the art will appreciate that the present methods for lead generation may be adapted to generate customer leads in other industries.

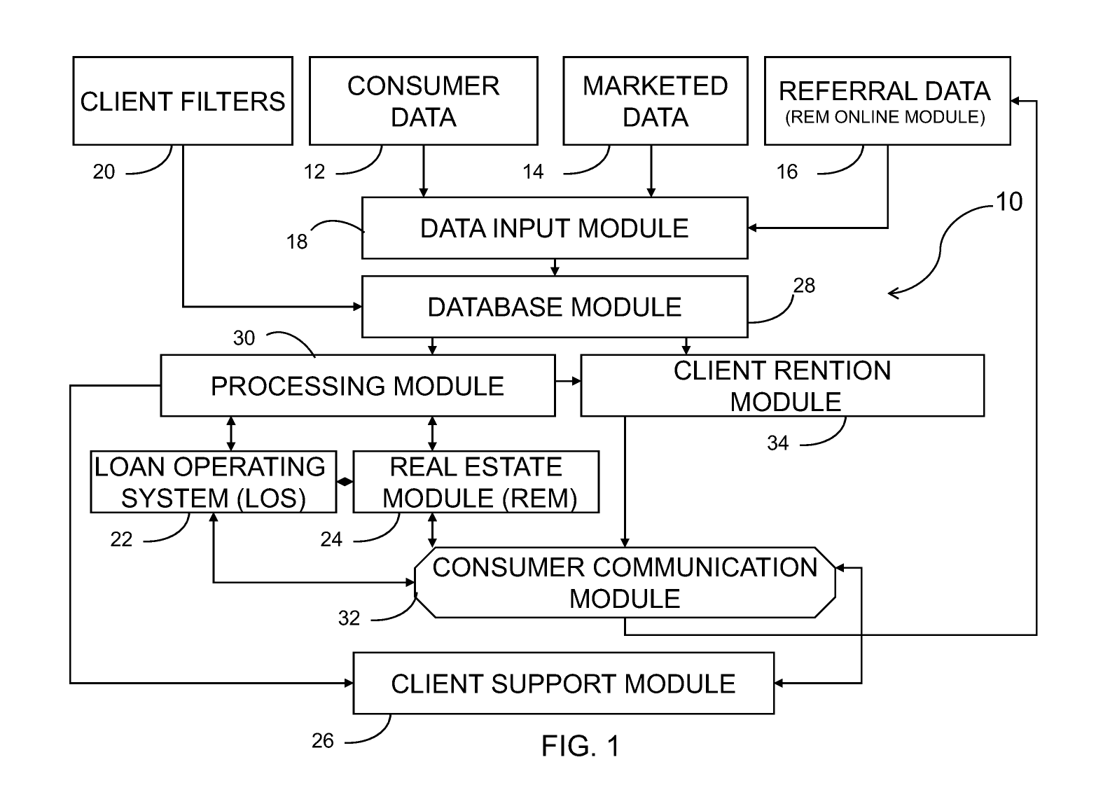

Referring now to FIG. 1, there is illustrated a schematic flow diagram of a computer software program, generally indicated at 10, that provides a method for generating customer leads. The computer software is configured to operate on a computer system, which may include one or more personal computers, network servers, mainframes, local area networks and/or Internet systems. The system utilizes consumer data 12, marketed data 14 and/or referral data 16 that are collected from outside or within the system and imported into the data input module 18.

Because the various data providers all export idiosyncratic feeds ranging from excel, CSV, XML, and other data types, each of these data feeds are mapped by the system of the present invention through an automated process to match industry standard formats that can be seamlessly imported into existing lead database software, such as that found on loan operating systems (LOS platforms). The fields of the LOS are provided by the software development kit (SDK) of the LOS. Thus, information about potential consumers is obtained and input into the data input module 18. The data input module 18 automatically converts the data from the file format in which it is received to a file format that is usable by a preexisting, third party, automated loan operating system (LOS). For example, the information may be imported into the lead origination software as an xml file, which is then converted into a proprietary SDK map, Fannie Mae and/or Freddie Mac compliant format, depending on the particular LOS of the customer. Each data source that is downloaded may be in a different format and may arrive in the form of a comma separated value file format (CSV) with different measurable and relative information. Some data feeds are downloaded and converted entirely automatically (e.g., XML feeds), see the XML map shown in TABLE 1.

TABLE 1

| XML Feed Data | LOS Object | LOS Fields |
|---|---|---|
| Imbid | NA | NA |
| LeadType int | | |
| LeadID int | | |
| DateCreated datetime | | |
| FirstName nvarchar(50) | Bor1 - CurrentResidence | FirstName |
| LastName nvarchar(50) | Bor1 - CurrentResidence | LastName |
| Email nvarchar(I28) | Bor1 | Email |
| SSN nvarchar(I1) | Bor1 | SSN |
| MaritalStatus nvarchar(75) | Bor1 | Maritalstatus |
| SpouseFirstName nvarchar(50) | NA | |
| SpouseLastName nvarchar(50) | NA | |
| MailStreetAddress nvarchar(100) | Bor1 - CurrentResidence | Street |
| MailCity nvarchar(50) | Bor1 - CurrentResidence | City |
| MailState nvarchar(2) | Bor1 - CurrentResidence | State |
| MailZipCode nvarchar(5) | Bor1 - CurrentResidence | Zip |
| BirthDate smalldatetime | Bor1 | DOB |
| GrossMonthlyIncome int | Bor1 | IncomeBase |
| OccupationalStatus nvarchar(75) | | |
| ErnployerName nvarchar(200) | Bor1 - PrimaryEmployer | Name |
| ErnploymentLength nvarchar(75) | | |
| B2-FirstName nvarchar(50) | Bor2 | FirstName |
| B2-LastName nvarchar(50) | Bor2 | LastName |
| B2-SSN nvarchar(1 I) | Bor2 | SSN |
| B2-MailStreetAddress nvarchar(100) | Bor2 | Street |
| B2-MailCity nvarchar(50) | Bor2 | cw |
| B2_MailState nvarchar(2) | Bor2 | State |
| B2-MailZipCode nvarchar(5) | Bor2 | Zip |
| B2-BirthDate smalldatetime | Bor2 | DOB |
| B2-GrossMonthlyIncome int | Bor2 | IncomeBase |
| Phone1 nvarchar(I0) | Bor1 | Multiple based on |
| | | Phone1Type |
| WorkPhoneExt1 nvarchar(6) | Bor1 - PrimaryEmployer | Phone1 + Ext1 |
| PhoneIType nvarchar(50) | | Used to Place Number |
| Phone2 nvarchar(I0) | | Multiple based on |
| | | Phone2Type |
| WorkPhoneExt2 nvarchar(6) | Bor1 - PrimaryEmployer | Phone2 + Ext2 |
| Phone2Type nvarchar(50) | | Used to Place Number |
| ContactTime nvarchar(50) | | |
| CreditProfile nvarchar(75) | Conversation | Notes |
| MonthlyDebtPayments int | | |
| DesiredLoanAmount int | Loan | BaseLoan |
| ExistingPropertyValue int | Loan | PurPrice |
| NewPropertyValue int | Loan | PurPrice |
| PropertyFound nvarchar(75) | | |
| IntendedPropertyUse nvarchar(75) | | |
| StreetAddress nvarchar(100) | SubProp | Street |
| City nvarchar(50) | SubProp | City |
| State nvarchar(2) | SubProp | State |
| ZipCode nvarchar(5) | SubProp | Zip |
| PropertyState nvarchar(2) | | |
| SeachZipCode nvarchar(5) | | |
| PropertyCounty nvarchar(50) | SubProp | County |
| PropertyDescription nvarchar(75) | SubProp | PropertyType |
| PropertyPurchasedYear int | SubProp | RYearLotAcq |
| FirstMortgageBalance int | SubProp | FirstMortBalance |
| FirstMortgageInterestRate numeric(8, 4) | | |
| SecondMortgageBalance int | SubProp | SecondMortBalance |
| SecondMortgageInterestRate numeric(8, 4) | | |
| DesiredRateType nvarchar(75) | | |
| DesiredMonthlyPayment int | | |
| FirstMortgageRateType nvarchar(75) | | |
| CurrentNeedSituation nvarchar(75) | | |
| LoanPurpose nvarchar(75) | Loan | RefiPurpAU |
| LoanType nvarchar(75) | Loan | Loan purpose |
| PreferredLoanType nvarchar(75) | | |
| LoanTimeFrame nvarchar(75) | | |
| Downpayment int | | |
| Bankruptcy nvarchar(75) | Bor1 | Bankruptcy |
| BankruptcyType nvarchar(75) | | |

Other data sources (e.g., CSV and Excel feeds) are emailed on a period basis (e.g., daily, weekly, etc.) from the various providers and manually pasted or ‘batched’ into the data module 18. In such cases the data module 18 reads the specific source data and maps the consumer information contained therein into the appropriate data field of the loan operating system, such as a HUD Compliant application form (Form 1003).

The system also provides various client filters 20 to determine the type of client (e.g., mortgage, real estate, etc.), to determine the quality of the client and to filter out clients that do not meet certain criteria. For example, the filter 20 may eliminate clients that have poor credit ratings or ratings below a particular value. The client filter 20 may also be configured to separate customers based on the client's particular needs or desires (e.g., type of loan, loan size, etc.) so that each client receives leads for the type of potential customer that they desire. Thus, the filter 20 is configured for eliminating certain potential customers based on specific values or criteria of the input data.

Further, the software 10 establishes triggers within the LOS to report information to the loan operating system (LOS) 22 user and/or the real estate module (REM) 24 user, as well as administrator (ADMIN) reports from the client support module (CRM) 26. The CRM 26 initiates different campaigns from the data obtained from the database module 28 and processing module 30. The database module 28 relays transaction specific data to initiate the transaction/consumer information sequence based upon the type of transaction the consumer is initiating. The processing module relays the client branding and client, transaction specific, information to the CRM 26. The CRM 26 also receives REM 24 client branding and REM 24 transaction specific data. The combination of these feeds initiates a highly relative product and client information email campaign to the consumer via a consumer communication module CCM 32. These email messages are delivered over a period of time typical or customary to the transaction type requested (e.g., 4-6 weeks). Consumer messaging is branded separately under the clients of the software of the present invention to provide each client with increased brand recognition with their specific customers. The messages to the end consumers via targeted emails help increase brand awareness to the end consumer. REM 24 clients are hosted on an internal website (e.g., www.agentreferrals.net). These feeds are mapped into the criteria needed for the particular LOS form, such as HUD Compliant application form 1003.

Once the potential consumer information is converted into a more useful format, the information can be automatically loaded into an automated LOS 22. Optionally, the consumer information may be downloaded into a customer retention module 34 (CRM). The CRM 34 may then be triggered to send introductory and/or informative emails by either a timing event, such as the download of the information, or by another event, such as the consumer clicking a link in a previously provided email, or by a loan origination officer indicating that the consumer was contacted and that further email should be sent to the consumer. The CRM 34 is triggered by the creation of a consumer record in the database that contains an email. From that point forward the CRM 34 is sent the specific transaction request—purchase or refinance, the client and user information and, when applicable, the REM 24 client. The email campaigns will continue on a timed basis until the consumer either unsubscribes or the campaign expires. The campaign initially serves to introduce the client to the consumer. The CRM 34 sends more email in the initial week, when the consumer's decision-making period is more critical in selecting a loan provider. Afterwards, the CRM 34 may provide less frequent emails, such as weekly informational emails branding the client and providing information relative the consumer's original request. As an example, a refinance client will receive and email a consumer to help the consumer understand such mortgage-related topics as closing costs, “break even points”, the difference between no fee and fee options and/or other items of potential specific interest to the consumer. Similarly, a potential homebuyer may receive emails detailing the importance of a home inspection, the importance of working with a qualified realtor, etc. Specific client transaction-based disclosures that reflect the changes in the transaction are produced by the user in the LOS 22 and emailed to the consumer using the LOS interface or via the CCM 32. These email updates are done frequently as information is available, as changes occur or as may be required by law.

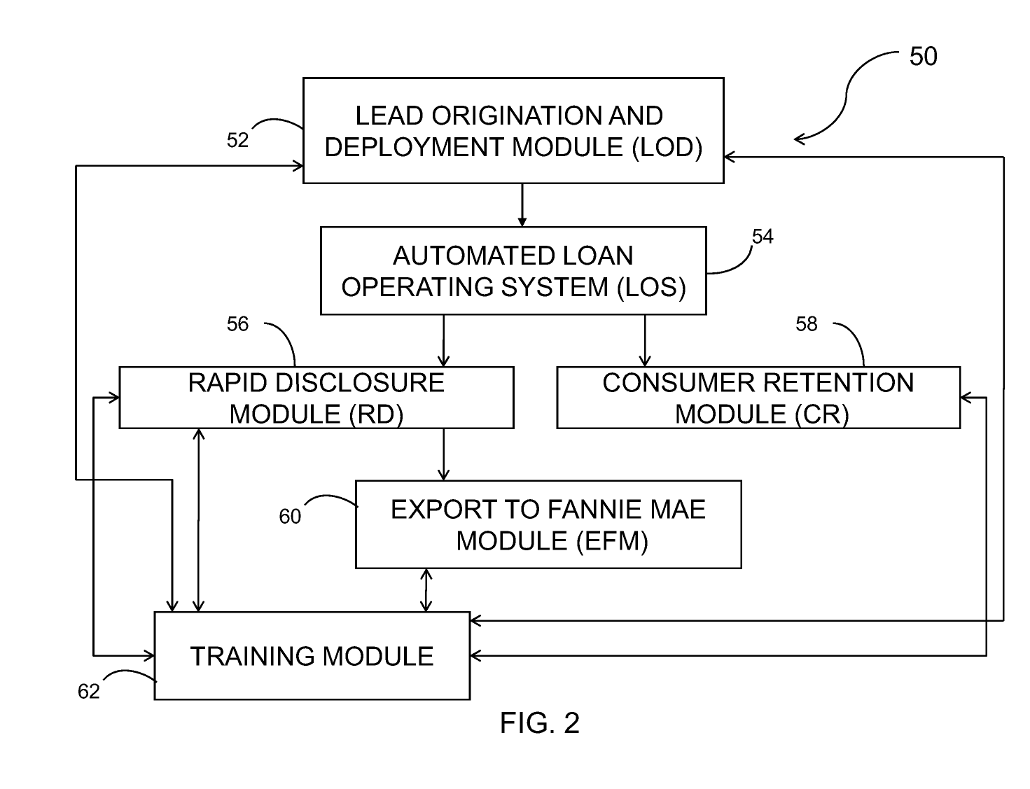

In an exemplary embodiment as shown in FIG. 2, the computer software, generally indicated at 50 comprises a bundle of interfunctional suites, including, but not limited to, a lead origination and deployment module (LOD) 52, an automated loan operating system (LOS) 54 with automatic upload of data, a rapid disclosure module (RD) 56, a consumer retention module (CR) 58 and an export to Fannie Mae module (EFM) 60. Each module may be an independent system, integrated into a single package or a combination thereof.

The RD module is configured to provide rapid disclosure of regulatory forms that, by law, must be sent to the consumer. After consultation with the user, a set of default, regulatory compliant, print sets are generated and established within the LOS. These print sets are selected from the regulatory forms that are required to be disclosed to the consumer, based on the particular transaction and enable the disclosure package to be quickly emailed to the consumer in a secure file format, such as an Adobe Portable Document Format (PDF).

The EFM module is provided to export data to Fannie Mae. When the print set of the disclosure documents has been accepted by the consumer a Fannie Mae data file is automatically created and exported online to Fannie Mae's website or system. Thus, the necessary information of the consumer is quickly and automatically transmitted to Fannie Mae.

As further shown in FIG. 2, the computer software includes a training module 62 where an end user, such as a loan originator, can interact with each of the various modules of the computer software of the system or simulated system in order to train the user one or more of the modules, procedures and/or functions. Such training may assist the user in more efficiently utilizing the modules, procedures and/or functions of the invention, and thereby increase the conversion of raw data into successfully concluded loans or real estate transactions and the revenue derived therefrom.

As shown in FIG. 1, the lead origination and deployment module 10 is designed and configured to accept various forms of data input (e.g., consumer data marketed data, etc.) and convert the fields into a usable residential loan application (e.g., a HUD 1003 form) or other form as may be required by the end user. The origination also cross sells home buying consumers through the real estate module (REM) 24 to REM end users, such as real estate agents or brokers that are users of the system 10. By accessing the system 10 via an Internet web page, such as through www.agentreferrals.net, the REM users can access and receive referral agreement forms. The webpage may require the users to log into the system 10 with a user name and password and to click to accept certain terms and conditions. Customer data gathered from a web page may also be input into the data input module 18.

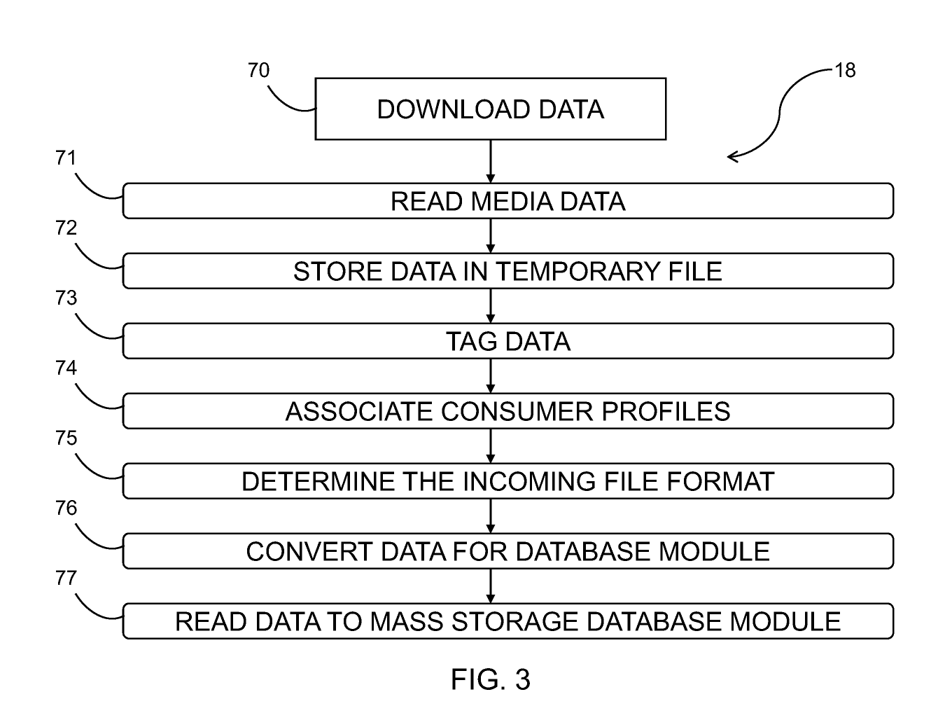

As illustrated in FIG. 3, the consumer data and marketed data may arrive at the system in many different forms. For example, the data may be in XML, CSV, or other formats and arrive to the system from various types of media or communication (e.g., modem, disk, tape, router, etc.). The data input module, generally indicated at 18, first downloads 70 the data. Once the data is downloaded 70, the data input module 18 reads 71 the media data. The media data is then stored 72 in a temporary file. The data input module 18 tags 73 the data and associates 74 consumer profiles. The system then determines 75 the format of the incoming data and converts 76 the data to a standard data form for the data module, such as a format usable in a residential loan application. The converted data is then read 77 to a mass storage data module, that organizes and stores the data in a database, for permanent storage.

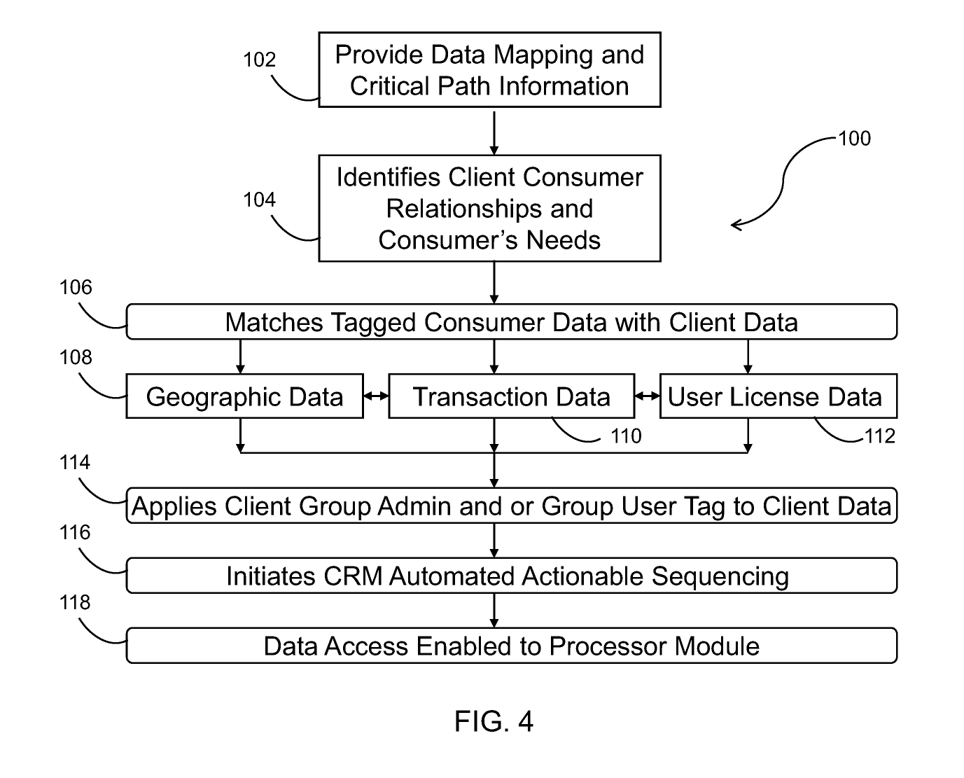

As shown in FIG. 4, the data module 100 provides 102 data mapping and critical path information and identifies 104 client/consumer relationships and consumer's needs. The consumer data is read to match 106 tagged consumer data with client or end user data. This includes geographic data 108, type of transaction data 110 and user license data 112. Doing so, the system will match a potential customer with an end user that has the capabilities to meet the needs of the potential customer. For example, if the user is seeking financing for a mortgage, the system will match that request with a loan originator that may be in the same geographic location as the consumer. The data module then applies 114 client group administration and/or group user tags to the client data. The system then initiates 116 the CRM automated actionable sequencing and sends 118 the data to the Processor Module.

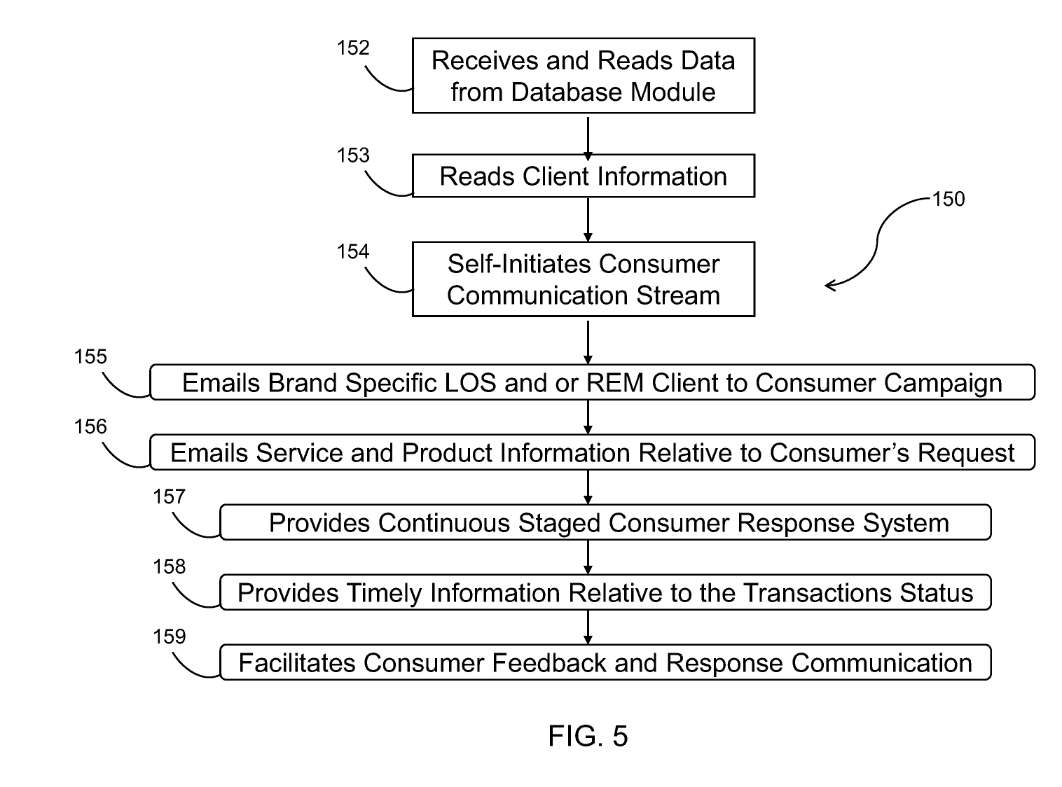

The client retention module 150, illustrated in FIG. 5, is provided to assist the end user of the system to not only obtain customer leads, but to retain those potential customers once the lead has been generated and initial contact with the customer has been made. The client retention module 150 provides automated customer communications with information relevant to the particular type of transaction and includes branding of the end user to the customer so that the customer believes that the communications are originating from the end user that is providing the loan or real estate service. As data is acquired by the lead origination software, this software automatically initiates a client retention module 150 that is intuitive. The client retention module 150 receives 152 and reads the data from the data module to ascribe, in the case of a loan whether the consumer is looking to “Purchase” or “Refinance”. The client retention module 150 then reads 153 the client information to which the consumer's request has been assigned. Each client has its own branding information and consumer tips to inform the consumer on the details of their transaction, the services they offer, the client's credentials, etc. When the consumer is requesting an agent to help them find a home or other real estate property, the CRM reads the request and begins the same sequencing on behalf of the REM Client.

The client retention module 150 self-initiates 154 a consumer communication stream. As such, the client retention module 150 automatically sends email messages 155 and 156 to the consumer. The emails 155 are brand specific to the LOC and/or REM client to provide an advertising campaign on behalf of the client. Emails 156 are also generated to provide service and product information relative to a consumer's request. The system also provides 157 continuous staged consumer responses, provides 158 timely (e.g., real-time) information relative to the transaction status and facilitates 159 consumer feedback and response through return communications. Thus, the system sends informative emails 155 and 156 to online consumers, where the email campaign is specifically adapted to meet the financing requests (purchase or refinance) of the online consumer. Individual emails 155 and 156 of the email campaign may be scheduled for periodic delivery (e.g. over 6-8 weeks). As a result, the software of the present invention delivers branding for the user, links back to the user's website, and provides value added messaging to help the consumer understand the dynamics of mortgage financing as it may apply to their specific request.

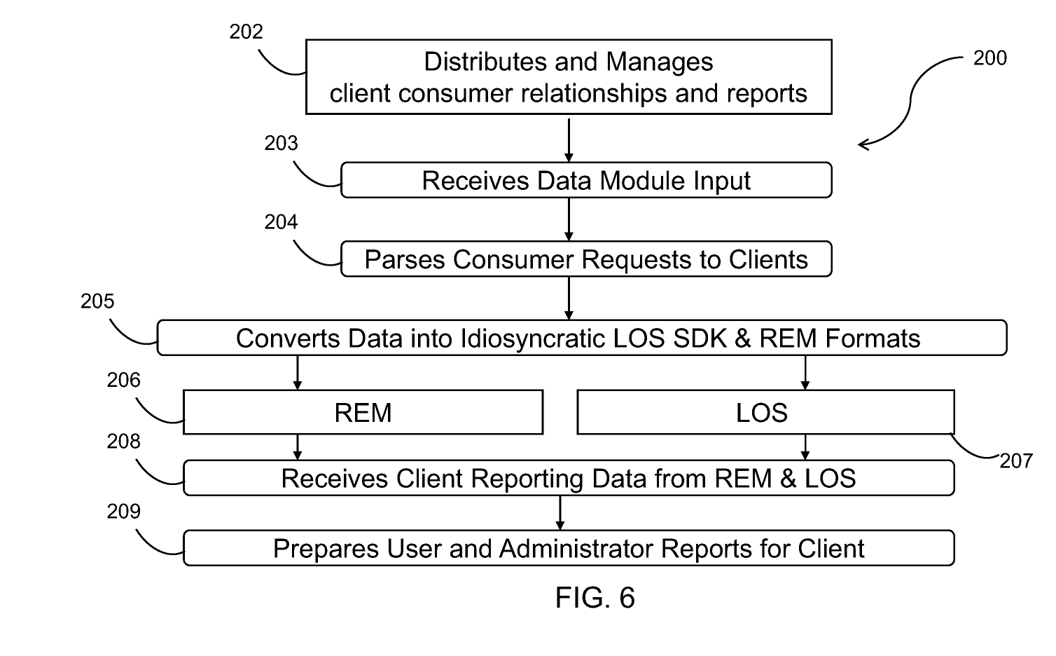

The processor module 200, as shown in FIG. 6, is configured to distribute and manage 202 client/consumer relationships and reports. The module 200 receives 203 data from the data input module and parses 204 specific consumer requests to specific clients. Thus, the system matches clients with consumers based upon matching criteria. The module 200 converts 205 the data into idiosyncratic LOS SKD and/or REM formats and sends the data to the REM and/or LOS module 206 and 207, respectively, depending on the type of transaction request of the consumer. The module 200 receives 208 client—reporting data from the REM and/or LOS modules 206 and 207, respectively, and prepares 209 user and administrator reports for the client so that the client can monitor status of individual transactions and receive reports to determine usage and efficiency of transaction completions.

The processor module also allows agent users and loan users to co-brand and update each other with respect to their shared client. Co-branding links may be provided on the web site between mortgage clients and their preferred agent referral (AR) client partners. For example, when an online user finds the AR agent page, mortgage links within the agents AR page direct the consumer to various mortgage partners associated with the system and vice versa. The system posts and hosts web-based branding pages (generated from CRM branding content) for system clients to be associated and co-branded together. Quick applications and full applications submitted by consumers are tagged by the data module and distributed accordingly by the process module 200.

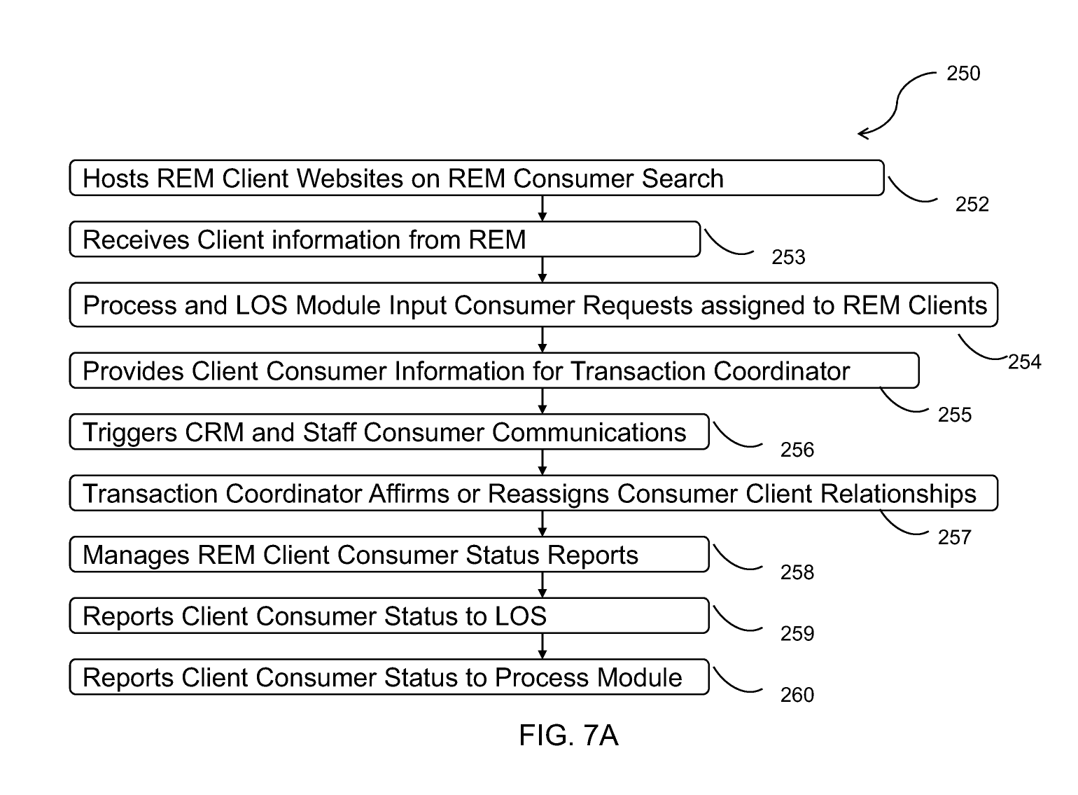

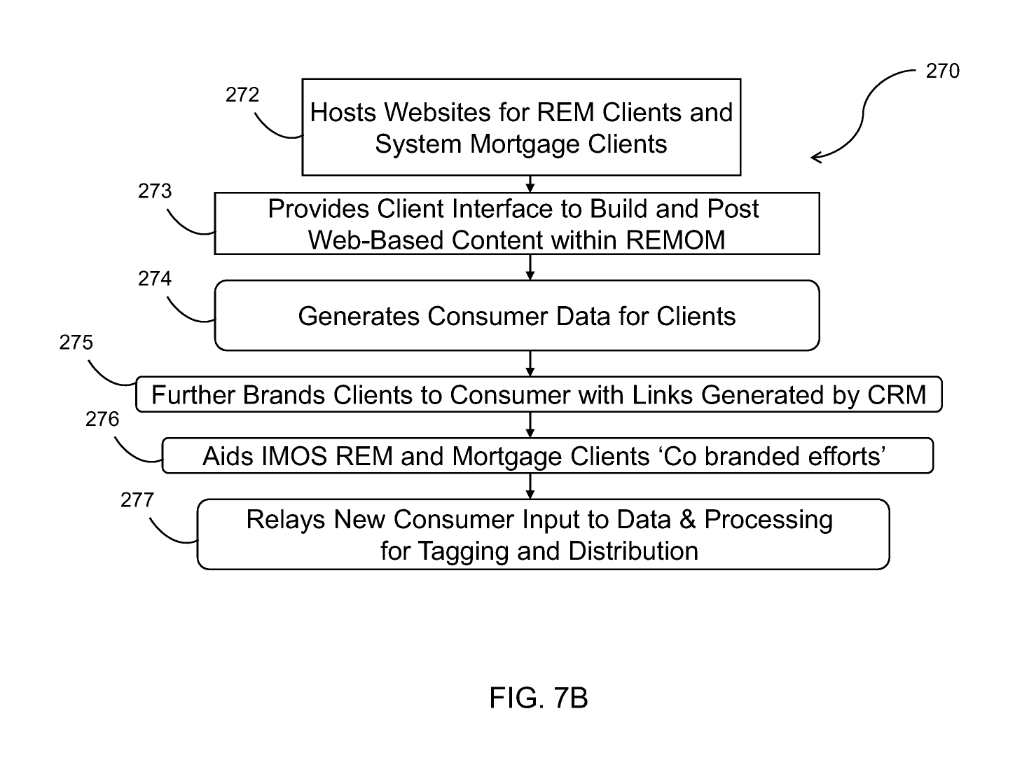

The real estate module (REM) 250 illustrated in FIG. 7A is capable of hosting REM client sites and receives data from the process module in order to assign specific real estate customers with REM clients. The REM hosts 252 REM client websites on a REM consumer search site, such as www.agentsreferrals.net. As a consumer inputs information about a particular potential real estate transaction, the REM receives 253 the information from the website in real-time. The process and LOS modules input consumer requests 254 assigned to REM clients into the system. The system then triggers 255 the CRM for staff and/or consumer communications. A transaction coordinator can affirm 256 or reassign consumer/client relationships. The REM also manages 258 REM client/consumer status reports, reports 259 client/consumer status to the LOS and reports 260 client/consumer status to the process module.

As further illustrated in FIG. 7B, the REM may include a REM online module (REMOM), generally indicated at 270. The REMOM hosts 272 websites for REM clients as well as mortgage clients of the system. The REMOM provides 273 a client interface to build and pose web-based content within the REMOM. The REMOM generates 274 consumer data received via the website for clients and further brands 275 clients to consumers with links generated by the CRM. Thus, the REMOM aids 276 REM and mortgage clients in their co-branding efforts. The REMOM relays 277 new consumer input data to the data and processing modules for tagging and distribution within the system.

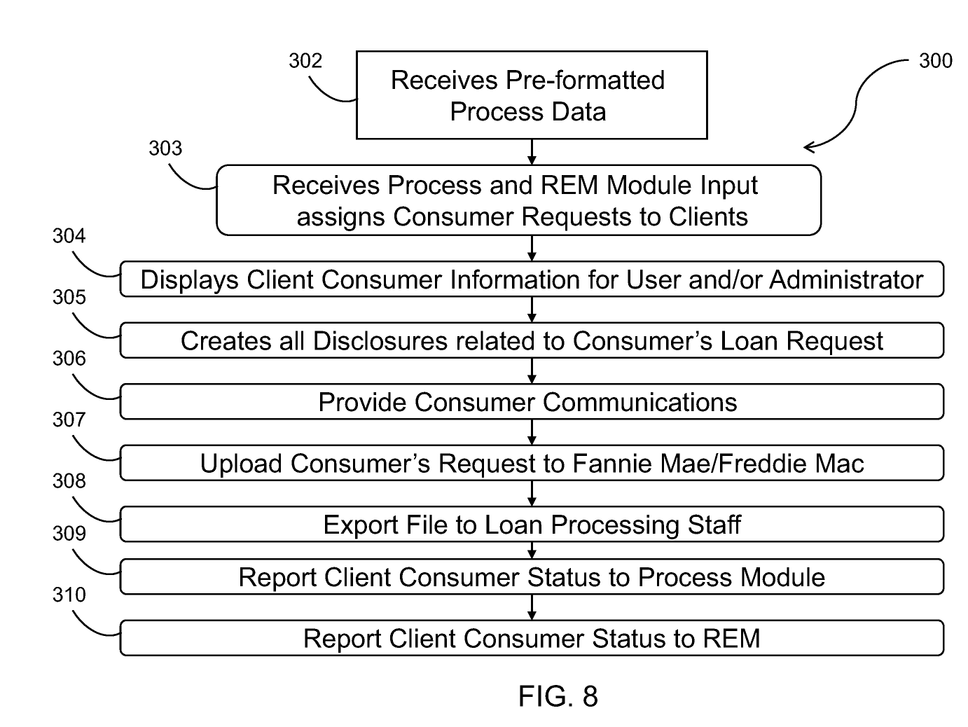

FIG. 8 illustrates a loan operating system (LOS), generally indicated at 300, in accordance with the principles of the present invention. The LOS receives 302 pre-formatted process data from the process module and/or REM and assigns consumer requests to clients. The LOS displays 304 client/consumer 1003 information for the user and/or administrator. All usable, applicable, fields and information that can be applied to a residential loan application, e.g., a HUD form 1003, are populated automatically for the end user using a software development kit (SDK), which may be provided by the source of the residential loan application populating program. For example, current residential loan application populating programs are commercially available from Byte, Calyx and Ellie Mae, however, other LOS platforms may also be used. Thus, the system of the present invention is designed to work with any LOS provider—given that they provide a SDK for mapping purposes. In addition, the system can work with any LOS provider without the SDK by exporting Fannie Mae 3.2 file formats—the most common import/export file format. Typically, the system will be functionally faster and more automated with the SDK as it allows the creation of 1003s without requiring the user to import the files manually using the LOS interface. In an exemplary embodiment, the user simply opens the LOS (e.g., Byte Enterprise LOS) and, by setting the LOS to an “auto refresh” mode, as leads are converted, new loan files simply appear in real time on the LOS. Thus, when an end user refreshes their LOS screen, new lead loan files are automatically imported into the LOS by the software of the present invention and become available to the end user to allow the end user to write, contact, disclose information, etc. to the consumer. The software may also provide configuration of the LOS in order to properly communicate and fully interact with the software of the present invention.

As further illustrated in FIG. 8, the LOS creates 305 all disclosures related to the consumer's loan request, provides 306 consumer communications, uploads 307 the consumer's request to Fannie Mae and/or Freddie Mac, exports 308 the file to the loan processing staff, reports 309 client/consumer status to the process module and reports 310 client/consumer status to the REM.

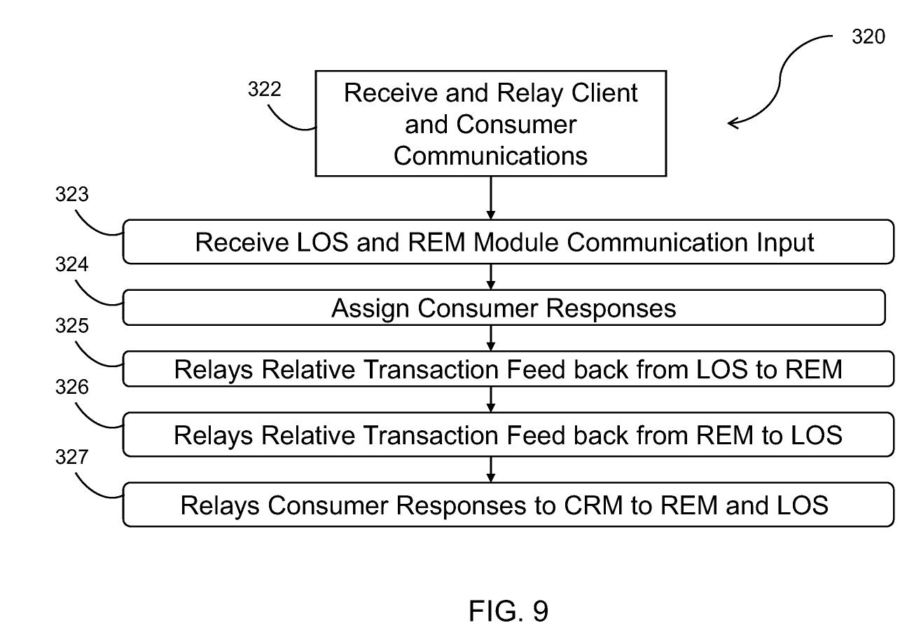

As shown in FIG. 9, the consumer or customer communication module (CCM), generally indicated at 320, is configured to receive and relay 322 client and/or consumer communications. The CCM receives 323 LOS and REM communication inputs and assigns 324 consumer responses. The CCM also relays 325 relative transaction feedback from the LOS to the REM and relays 326 from the REM to the LOS. The CCM also relays 327 consumer responses to the CRM, REM and LOS.

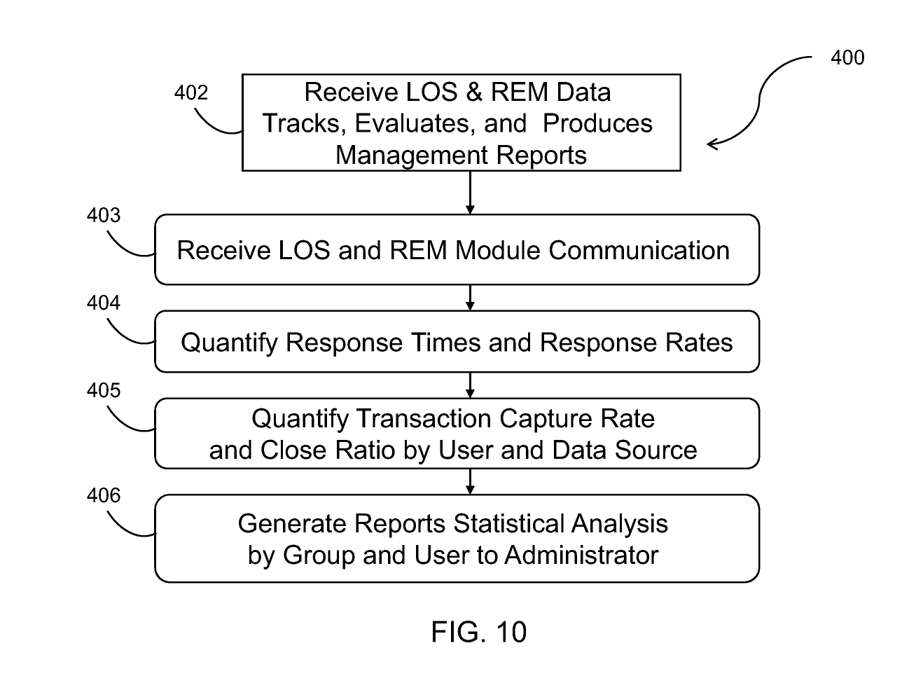

As illustrated in FIG. 10, the client support module (CSM), generally indicated at 400, is configured to receive 402 LOS and REM data and to track, evaluate and produce management reports. This allows the end user to monitor its own system usage to determine, among other things, how effectively the system is being used. The CSM receives 403 LOS and REM communications and quantifies 404 response times, response rates, etc. for a particular user and/or client. The CSM also quantifies 405 transaction capture rate and close ratio by user and by data source. The CSM then generates 406 reports using statistical analysis by group and/or user and sends the report to the system administrator of the client.

The system provides an interface that is compatible with any LOS platform. The software of the present invention provides a “plug in” tool that works with current LOS systems to automatically input data into the LOS such that the user simply sees new lead loan applications appear in their respective LOS. In some circumstances, the LOS may require customary manual data input for any fields not captured by the lead origination software of the present invention or provided by the initial data source.

In another exemplary embodiment of the system of the present invention, the system is provided with a module for provide automated responses to quote requests received via third party marketplace websites, such as requests for loan rate quotes for mortgages and/or home equity lines of credit offered through such websites as www.zillow.com, www.interest.com or www.bankrate.com. Third party lenders typically pay a fee to marketplace websites in order to be listed as a potential lender when a loan request is entered that matches certain criteria. For example, a lender may request only to be listed when a loan request is for a specific type of loan on property located in a particular state, that is within a certain dollar amount range, and for potential customers having a certain credit rating. Even with such restrictions in place, lenders often receive dozens, if not hundreds, of requests each week. The requests are commonly sent to an email account, requiring the lender to review each request, include the day's current rate information and send the information via return email to the potential customer. Because of the large volume of requests, it is the case that lenders spend a significant amount of time responding to such requests and may even fail to respond to some requests that results in lost business.

According to the present invention, when a customer requests a rate quote through a particular website, the data posted by the potential customer is received by the system and directed to a user editable HTML page that will reply back to the website with the corresponding quote for the lender/system user. The HTML page is editable by the lender and allows the lender to input fees and rates that match the website's feed. The HTML form is updated on at least a daily basis by the lender so that current market information (e.g., current interest rate, fees, etc.) of the particular lender is provided. The HTML page is accessed through an integration interface of the system, which may be web-based. On weekends and federal holidays when lenders are typically closed for business, the interface will cease to respond to the rate quote requests in the event the rate table has not been updated or confirmed as “no change required” by the user.

Other systems typically require the user to maintain and pay for the services of both a lead interface (typically a flat fee) to read and respond to web-based loan quote requests and a pricing engine to auto-price from the lender's rate sheets (typically $0.20 to $0.25 per auto-quote). The user's ability to update its quote information on a daily basis through the rate quote module of the present invention will not only constitute a substantial cost savings for the user, it will also allow the user to take advantage of a “spread” in quoting the optimum rates and fees. That is, by manually setting the quote relative to consumer requests and the “spread” between the available rates, the user will be able to optimize the fee/rate structure presented to the potential customer. In other words, the user can adjust the rates and fees associated with a specific loan request or set of requests in order to optimize its particular loan terms appear more competitive to the consumer (e.g., adjusting the interest rate and/or the fees).

Once the lender has edited the HTML page for a particular day, when rate quote requests are received via the third party source, the system can be configured to automatically respond using the HTML page. The HTML page is configured to integrate with a particular third party's website. Thus, the system may provide multiple HTML pages, one for interfacing with each third party website. While the fully automated version cannot make key pricing decisions designed to satisfy the online consumer's value proposition, current systems in the market are limited to simply ensure a margin over cost analysis. The loan quote module of the present invention allows the user to review the day's available interest rates and related interest rate spreads and send quotes out with consumer perception in mind at a fraction of the cost of other comparable systems.

The system is also configured to integrate with certain external software programs used by end user's, such as Microsoft Outlook. For example, an end user, while working in an LOS environment, can create calendar events that are automatically exported by the system into the user's Outlook calendar. Also by way of example, the system provides a means for creation and entry of a calendar event, such as a customer meeting, a reminder to contact the customer on the anniversary of closing of a loan, etc. Once the event is created by entry of such information as the name of the customer, the date and time of the event, the length of the event, etc., the event is automatically sent to and entered in the user's Outlook calendar. As such, the system of the present invention is seamlessly integrated into the user's other software programs.

While there have been described what are believed to be the best embodiments of the present invention, those skilled in the art will recognize that other and further changes and modifications may be made thereto without department from the spirit of the invention, and it is intended to claim all such changes and modifications that fall within the true scope of the invention. In addition, while the methods and systems set forth herein have been described with specific reference to loan origination and mortgage lead generation, the system and methods of the present invention could be adapted to be used for other types of lead generation. For example, auto retailers seeking real-time lead generation for customers looking for automobiles in their geographic location could be provided with data relevant to potential automobile customers, such as type of car, geographic location, purchase price range, income, credit score, etc. Thus, the same types of filters used for providing quality loan generation leads could be used to provide quality leads for potential automobile customers. Likewise, the software could be configured for lead generation for insurance companies to provide quality leads of potential customers seeking home, life or automobile insurance.

Unless defined otherwise, all technical and scientific terms used herein have the same meanings as commonly understood by one of ordinary skill in the art to which this invention belongs. The term “module” as herein used is intended to encompass any stand-alone or integrated software component or subcomponent that is capable of being employed by the system to perform a certain function or group of functions. The term “module is not intended to be limited to computer code that separates functions into discrete or separate parts accessible through a common interface but is used to describe, in general, the functionality of a particular part of the software that may be integrated into the system. It is also to be understood that, as used herein and in the appended claims, the singular forms “a,” “an,” and “the” include plural reference, unless the context clearly dictates otherwise.

While various methods and systems of the present invention are described herein, any methods or systems similar or equivalent to those described herein may by used in the practice or testing of the present invention. All references cited herein are incorporated by reference in their entirety and for all purposes.

While the foregoing advantages of the present invention are manifested in the illustrated embodiments of the invention, a variety of changes can be made to the configuration, design and construction of the invention to achieve those advantages, including without limitation various combinations of the described embodiments of the present invention. Hence, reference herein to specific details of the method and function of the present invention is by way of example only and not by way of limitation.

What is claimed is:

1. Computer software for generating customer leads, comprising:
a data input module for receiving potential customer data from an outside source and converting the data into a format compatible with preexisting software of an end user;
a data storage module for storing the converted data; and
a processing module for processing the converted data to determine a transaction type and for forwarding the converted data to the user based upon the determined transaction type;
whereby the converted data is displayable on a computer screen of the user by the preexisting software and provides the determined transaction type and client contact information.

2. The computer software of claim 1, further comprising at least one client filter in communication with the data storage module for eliminating certain potential customers based on the input data.

3. The computer software of claim 1, further comprising a client retention module for providing automated customer communications containing information relevant to the determined transaction type.

4. The computer software of claim 3, wherein the client retention module further provides customer communications containing branding of the end user to the customer so that the customer communications appear to have originated from the end user.

5. The computer software of claim 1, further comprising a loan operation system.

6. The computer software of claim 1, further comprising a rapid disclosure module for providing required disclosure documents to the customer.

7. The computer software of claim 6, further comprising an export to Fannie Mae Module for automatically exporting the required disclosure documents to Fannie Mae.

8. The computer software of claim 1, wherein the data input module is configured for downloading and reading the data, tagging the data, associating the tagged data with consumer profiles, determining the format of the incoming data and converting the data to a standard data form for the data storage module.

9. The computer software of claim 1, wherein the data storage module identifies at least one client/consumer relationships to match a potential customer with an end user that has the capability to meet a need of the potential customer.

10. The computer software of claim 3, wherein the client retention module automatically sends email messages to the customer to provide at least one of an advertising campaign on behalf of the client, service and product information relative to a customer's request, continuous staged consumer responses and information relating to the transaction status.

11. The computer software of claim 1, wherein the processor module matches clients with consumers based upon matching criteria.

12. The computer software of claim 1, further comprising a real estate module configured for hosting a real estate client site and receiving data from the processing module in order to assign specific real estate customers with real estate clients.

13. The computer software of claim 5, wherein the loan operating system is configured for receiving data from the processing module, assigning customer requests to clients, displaying client/consumer information, creating disclosure documents related to the customer's loan request and providing consumer communications.

14. The computer software of claim 1, further comprising a customer communication module configured for receiving and relaying client or consumer communications.

15. The computer software of claim 1, further comprising a client support module configured for receiving loan operating and real estate module data and to track, evaluate and produce management reports.

16. A method for generating customer leads performed by a computer system, comprising:
receiving potential customer data from an outside source and converting the data into a format compatible with preexisting software of an end user;
storing the converted data; and
processing the converted data to determine a transaction type and for forwarding the converted data to the user based upon the determined transaction type;
whereby the converted data is displayable on a computer screen of the user by the preexisting software and provides the determined transaction type and client contact information.

17. The computer software of claim 16, further comprising filtering the input data to eliminate certain potential customers based on the input data.

18. The computer software of claim 16, further comprising providing automated customer communications containing information relevant to the determined transaction type.

19. The method of claim 18, further comprising providing customer communications containing branding of the end user to the customer so that the customer communications appear to have originated from the end user.

20. The method of claim 16, further comprising providing a loan operation system.

21. The method of claim 16, further comprising providing required disclosure documents to the customer.

22. The method of claim 21, further comprising automatically exporting the required disclosure documents to Fannie Mae.

23. The method of claim 16, further comprising downloading and reading the data, tagging the data, associating the tagged data with consumer profiles, determining the format of the incoming data and converting the data to a standard data form for the data storage module.

24. The method of claim 16, further comprising identifying at least one client/consumer relationships to match a potential customer with an end user that has the capability to meet a need of the potential customer.

25. The method of claim 18, further comprising automatically sending email messages to the customer to provide at least one of an advertising campaign on behalf of the client, service and product information relative to a customer's request, continuous staged consumer responses and information relating to the transaction status.

26. The method of claim 16, further comprising matching clients with consumers based upon matching criteria.

27. The computer software of claim 16, further comprising hosting a real estate client site and receiving data in order to assign specific real estate customers with real estate clients.

28. The method of claim 20, further comprising assigning customer requests to clients, displaying client/consumer information, creating disclosure documents related to the customer's loan request and providing consumer communications.

29. The method of claim 16, further comprising receiving and relaying client or consumer communications.

30. The method of claim 16, further comprising a receiving loan operating and real estate module data and tracking, evaluating and producing management reports.
